(19) United States
(12) Patent Application Publication
(10) Pub. No.: US 2025/0024309 A1
(43) Pub. Date: Jan. 16, 2025

(54) APPLICATION ASSISTED UPLINK DATA STALL DETECTION AND MITIGATION

(71) Applicant: QUALCOMM Incorporated, San Diego, CA (US)

(72) Inventors: Jiaheng LIU, Shanghai (CN); Arvind Vardarajan SANTHANAM, San Diego, CA (US); Mouaffac AMBRISS, San Diego, CA (US); Nanrun WU, Beijing (CN); Kuo-Chun LEE, San Diego, CA (US); Yuyi LI, Shanghai (CN); Rong YANG, Kanata (CA); Zhengyi LI, Shanghai (CN); Yunjia NIU, Shanghai (CN); Xuqiang ZHANG, Beijing (CN); Tom CHIN, San Diego, CA (US); Wei-Jei SONG, San Diego, CA (US)

(21) Appl. No.: 18/712,130

(22) PCT Filed: Jan. 19, 2022
(86) PCT No.: PCT/CN2022/072695

§ 371 Date: May 21, 2024

(51) Int. Cl. H04W 28/02; H04W 24/10; H04W 72/1268; H04W 76/15

(52) U.S. Cl. CPC H04W 28/0236; H04W 24/10; H04W 72/1268; H04W 76/15

(57) ABSTRACT

Various aspects of the present disclosure generally relate to wireless communication. In some aspects, a user equipment (UE) may receive, from an application processor associated with the UE, an indication of a traffic service type and whether an uplink data stall has occurred. The UE may detect that one or more threshold criteria are satisfied for a serving cell, wherein a threshold value associated with at least one of the one or more threshold criteria is based at least in part on the traffic service type. The UE may transmit information associated with one or more adjusted measurement values of the serving cell based at least in part on detecting that the one or more threshold criteria are satisfied. Numerous other aspects are described.

### FIELD OF THE DISCLOSURE

Aspects of the present disclosure generally relate to wireless communication and to techniques and apparatuses for application assisted uplink data stall detection and mitigation.

### BACKGROUND

Wireless communication systems are widely deployed to provide various telecommunication services such as telephony, video, data, messaging, and broadcasts.

Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a UE. The method may include receiving, by a modem of the UE and from an application processor associated with the UE, an indication of a traffic service type and whether an uplink data stall has occurred. The method may include detecting that one or more threshold criteria are satisfied for a serving cell, wherein a threshold value associated with at least one of the one or more threshold criteria is based at least in part on the traffic service type. The method may include transmitting information associated with one or more adjusted measurement values of the serving cell based at least in part on detecting that the one or more threshold criteria are satisfied.

Some aspects described herein relate to a UE for wireless communication. The UE may include a memory and one or more processors coupled to the memory. The one or more processors may be configured to receive, from an application processor associated with the UE, an indication of a traffic service type and whether an uplink data stall has occurred. The one or more processors may be configured to detect that one or more threshold criteria are satisfied for a serving cell, wherein a threshold value associated with at least one of the one or more threshold criteria is based at least in part on the traffic service type. The one or more processors may be configured to transmit information associated with one or more adjusted measurement values of the serving cell based at least in part on detecting that the one or more threshold criteria are satisfied.

Some aspects described herein relate to a non-transitory computer-readable medium that stores a set of instructions for wireless communication by a UE. The set of instructions, when executed by one or more processors of the UE, may cause the UE to receive, from an application processor associated with the UE, an indication of a traffic service type and whether an uplink data stall has occurred. The set of instructions, when executed by one or more processors of the UE, may cause the UE to detect that one or more threshold criteria are satisfied for a serving cell, wherein a threshold value associated with at least one of the one or more threshold criteria is based at least in part on the traffic service type. The set of instructions, when executed by one or more processors of the UE, may cause the UE to transmit information associated with one or more adjusted measurement values of the serving cell based at least in part on detecting that the one or more threshold criteria are satisfied.

Some aspects described herein relate to an apparatus for wireless communication. The apparatus may include means for receiving, from an application processor associated with the apparatus, an indication of a traffic service type and whether an uplink data stall has occurred. The apparatus may include means for detecting that one or more threshold criteria are satisfied for a serving cell, wherein a threshold value associated with at least one of the one or more threshold criteria is based at least in part on the traffic service type. The apparatus may include means for transmitting information associated with one or more adjusted measurement values of the serving cell based at least in part on detecting that the one or more threshold criteria are satisfied.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of dual connectivity, in accordance with the present disclosure.

FIG. 4 is a diagram illustrating an example associated with application assisted uplink data stall detection and mitigation, in accordance with the present disclosure.

FIG. 5 is a diagram illustrating an example process performed, for example, by a UE, in accordance with the present disclosure.

FIG. 6 is a diagram of an example apparatus for wireless communication, in accordance with the present disclosure.

FIG. 7 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

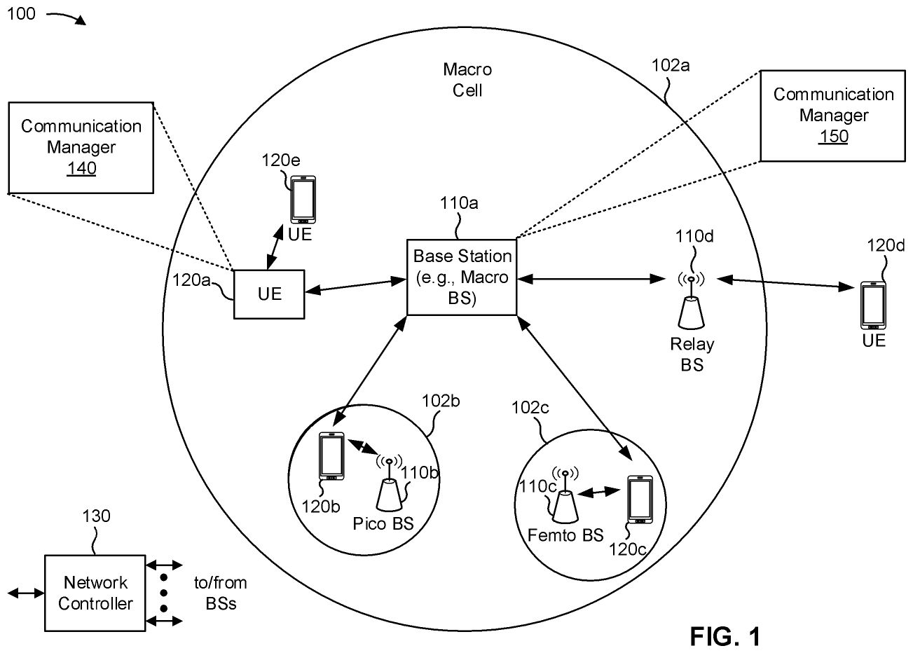

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from an application processor associated with the UE, an indication of a traffic service type and whether an uplink data stall has occurred; detect that one or more threshold criteria are satisfied for a serving cell, wherein a threshold value associated with at least one of the one or more threshold criteria is based at least in part on the traffic service type; and transmit information associated with one or more adjusted measurement values of the serving cell based at least in part on detecting that the one or more threshold criteria are satisfied. Additionally, or alternatively, the communication manager 140 may perform one or more other operations described herein.

In some aspects, the base station 110 may include a communication manager 150. As described in more detail elsewhere herein, the communication manager 150 may receive, from a UE, a measurement report that includes one or more adjusted measurement values; and perform an action to hand over the UE from a first cell to a second cell based at least in part on the measurement report. Additionally, or alternatively, the communication manager 150 may perform one or more other operations described herein.

As indicated above, FIG. 1 is provided as an example. Other examples may differ from what is described with regard to FIG. 1.

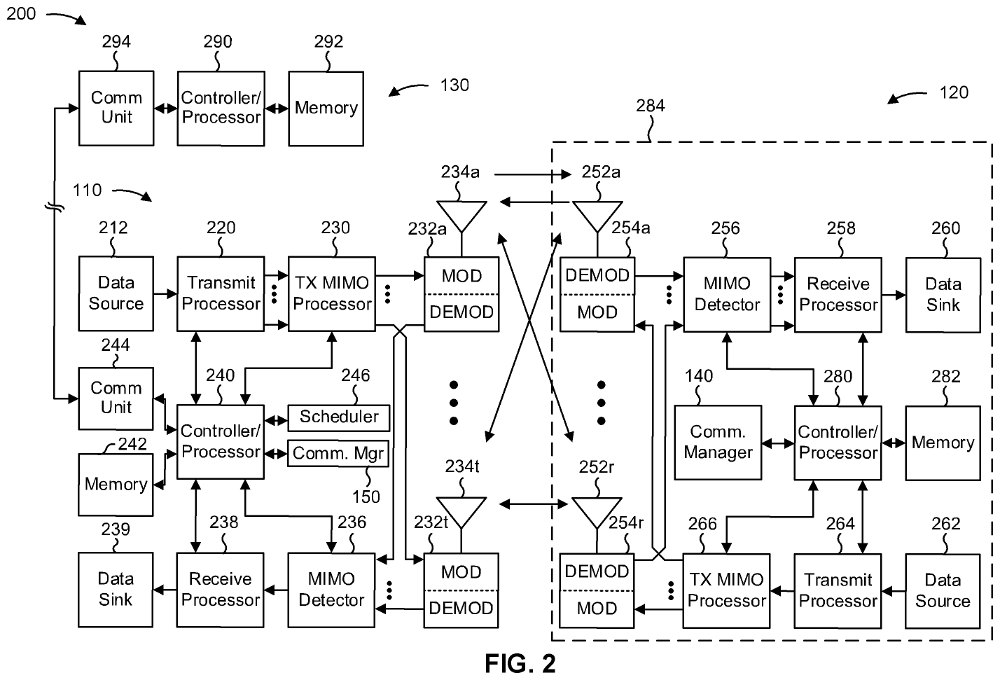

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

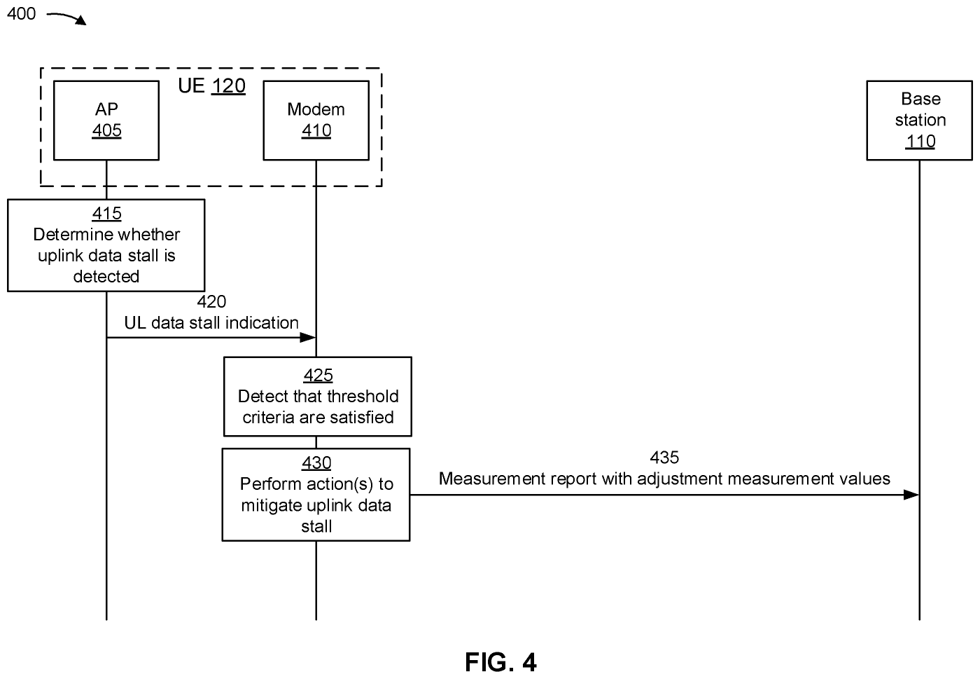

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-7).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-7).

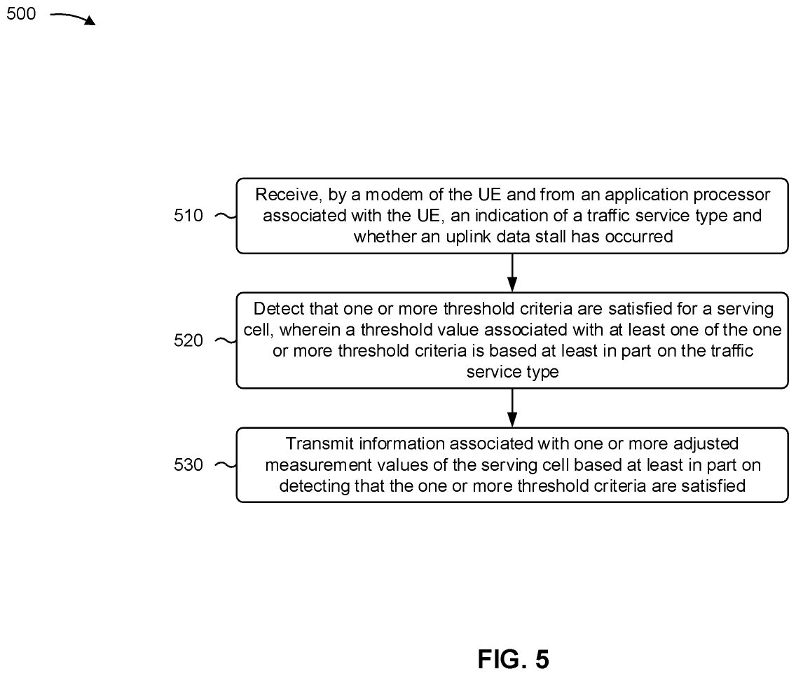

The controller/processor 240 of the base station 110, the controller/processor 280 of the UE 120, and/or any other component(s) of FIG. 2 may perform one or more techniques associated with application assisted uplink data stall detection and mitigation, as described in more detail elsewhere herein. For example, the controller/processor 240 of the base station 110, the controller/processor 280 of the UE 120, and/or any other component(s) of FIG. 2 may perform or direct operations of, for example, process 500 of FIG. 5 and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5 and/or other processes as described herein. In some examples, executing instructions may include running the instructions, converting the instructions, compiling the instructions, and/or interpreting the instructions, among other examples.

In some aspects, the UE 120 includes means for receiving, by a modem of the UE and from an application processor associated with the UE, an indication of a traffic service type and whether an uplink data stall has occurred; means for detecting that one or more threshold criteria are satisfied for a serving cell, wherein a threshold value associated with at least one of the one or more threshold criteria is based at least in part on the traffic service type; and/or means for transmitting information associated with one or more adjusted measurement values of the serving cell based at least in part on detecting that the one or more threshold criteria are satisfied. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

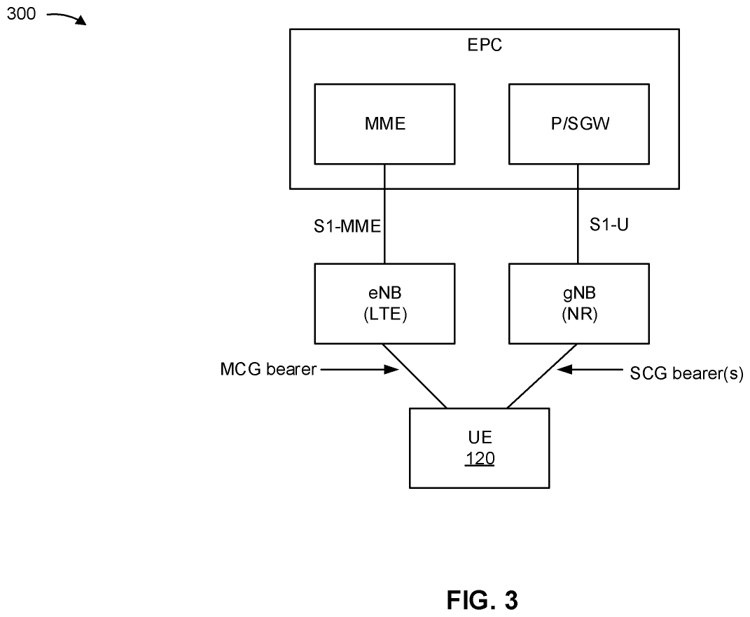

FIG. 3 is a diagram illustrating an example 300 of dual connectivity, in accordance with the present disclosure. The example shown in FIG. 3 is for an Evolved Universal Mobile Telecommunications System Terrestrial Radio Access (E-UTRA)-NR dual connectivity (ENDC) mode. In the ENDC mode, a UE 120 communicates using an LTE RAT on a master cell group (MCG), and the UE 120 communicates using an NR RAT on a secondary cell group (SCG). However, aspects described herein may apply to an ENDC mode (e.g., where the MCG is associated with an LTE RAT and the SCG is associated with an NR RAT), an NR-E-UTRA dual connectivity (NEDC) mode (e.g., where the MCG is associated with an NR RAT and the SCG is associated with an LTE RAT), an NR dual connectivity (NRDC) mode (e.g., where the MCG is associated with an NR RAT and the SCG is also associated with the NR RAT), or another dual connectivity mode (e.g., where the MCG is associated with a first RAT and the SCG is associated with one of the first RAT or a second RAT). The ENDC mode is sometimes referred to as an NR or 5G non-standalone (NSA) mode. Thus, as used herein, “dual connectivity mode” may refer to an ENDC mode, an NEDC mode, an NRDC mode, and/or another type of dual connectivity mode.

As shown in FIG. 3, a UE 120 may communicate with both an eNB (e.g., a 4G base station 110) and a gNB (e.g., a 5G base station 110), and the eNB and the gNB may communicate (e.g., directly or indirectly) with a 4G/LTE core network, shown as an evolved packet core (EPC) that includes a mobility management entity (MME), a packet data network gateway (PGW), a serving gateway (SGW), and/or other devices. In FIG. 3, the PGW and the SGW are shown collectively as P/SGW. In some examples, the eNB and the gNB may be co-located at the same base station 110. In some examples, the eNB and the gNB may be included in different base stations 110 (e.g., may not be co-located).

As further shown in FIG. 3, in some examples, a wireless network that permits operation in a 5G NSA mode may permit such operations using an MCG for a first RAT (e.g., an LTE RAT or a 4G RAT) and an SCG for a second RAT (e.g., an NR RAT or a 5G RAT). In this case, the UE 120 may communicate with the eNB via the MCG, and may communicate with the gNB via the SCG. In some examples, the MCG may anchor a network connection between the UE 120 and the 4G/LTE core network (e.g., for mobility, coverage, and/or control plane information), and the SCG may be added as additional carriers to increase throughput (e.g., for data traffic and/or user plane information). In some examples, the gNB and the eNB may not transfer user plane information between one another. In some examples, a UE 120 operating in a dual connectivity mode may be concurrently connected with an LTE base station 110 (e.g., an eNB) and an NR base station 110 (e.g., a gNB) (e.g., in the case of ENDC or NEDC), or may be concurrently connected with one or more base stations 110 that use the same RAT (e.g., in the case of NRDC). In some examples, the MCG may be associated with a first frequency band (e.g., a sub-6 GHz band and/or an FR1 band) and the SCG may be associated with a second frequency band (e.g., a millimeter wave band and/or an FR2 band).

The UE 120 may communicate via the MCG and the SCG using one or more radio bearers (e.g., data radio bearers (DRBs) and/or signaling radio bearers (SRBs)). For example, the UE 120 may transmit or receive data via the MCG and/or the SCG using one or more DRBs. Similarly, the UE 120 may transmit or receive control information (e.g., radio resource control (RRC) information and/or measurement reports) using one or more SRBs. In some examples, a radio bearer may be dedicated to a specific cell group (e.g., a radio bearer may be an MCG bearer or an SCG bearer). In some examples, a radio bearer may be a split radio bearer. A split radio bearer may be split in the uplink and/or in the downlink. For example, a DRB may be split on the downlink (e.g., the UE 120 may receive downlink information for the MCG or the SCG in the DRB) but not on the uplink (e.g., the uplink may be non-split with a primary path to the MCG or the SCG, such that the UE 120 transmits in the uplink only on the primary path). In some examples, a DRB may be split on the uplink with a primary path to the MCG or the SCG. A DRB that is split in the uplink may transmit data using the primary path until a size of an uplink transmit buffer satisfies an uplink data split threshold. If the uplink transmit buffer satisfies the uplink data split threshold, the UE 120 may transmit data to the MCG or the SCG using the DRB.

As shown in FIG. 3, a UE operating in a dual connectivity mode may be associated with two or more connections (e.g., a first connection associated with a first RAT and/or an MCG and a second connection associated with a second RAT and/or an SCG). The connections of the dual connectivity mode may be referred to as “legs” herein. For example, when operating in a dual connectivity mode, a UE may communicate via a first leg and/or a second leg.

As indicated above, FIG. 3 is provided as an example. Other examples may differ from what is described with respect to FIG. 3.

In some communications systems, an uplink data stall scenario may occur where a UE has a low uplink throughput (e.g., less than a threshold, such as less than 400 bytes per second (bytes/s)) on a particular cell. Therefore, as used herein, “uplink data stall” may refer to a situation in which an uplink throughput of a UE is less than a threshold (e.g., while a downlink throughput remains relatively constant and/or greater than or equal to another threshold). A low uplink throughput may result in excessive delays in data transfer or poor user experience, among other examples. Despite the low uplink throughput on the particular cell, the UE may experience relatively high downlink throughput (e.g., greater than a threshold throughput) with a relatively low block error rate (BLER) (e.g., less than a threshold BLER).

In one example, an uplink data stall scenario may occur when the UE is receiving relatively few or small uplink grants even as a buffer status report (BSR) value increases. In another example, an uplink data stall scenario may occur when the BSR value is relatively low, but the UE is receiving relatively few or small uplink grants and a packet data convergence protocol (PDCP) discard rate is greater than a size of the uplink grants. After a period of time experiencing the aforementioned an uplink data stall scenario, the UE may transfer from the particular cell to another cell, such as via a handover (HO) procedure or a radio link failure (RLF) procedure. However, a delay in triggering or initiating the HO procedure or RLF procedure may result in an excessive period of time with the aforementioned excessive delay in data transfer or poor user experience, among other examples.

In some cases, the UE (e.g., a modem of the UE) may detect and mitigate an uplink data stall by determining that one or more threshold criteria are satisfied for a serving cell and classifying the serving cell as a problematic cell. The UE may apply a penalty to an RSRP reported in one or more measurement reports associated with the serving cell. This may reduce an amount of delay in the base station initiating a HO procedure or an RLF procedure, thereby reducing an amount of time to transfer the UE from the problematic cell to another cell. However, when determining whether the one or more threshold criteria are satisfied for the serving cell, the UE may use the same values for the one or more threshold criteria (e.g., the same threshold values) for all traffic types and all operation modes. However, some traffic types and/or operation modes may be associated with different scenarios for triggering an uplink data stall. Therefore, using the same values for the one or more threshold criteria (e.g., the same threshold values) for all traffic types and all operation modes may result in some uplink data stalls being missed by the UE (e.g., not detected by the UE) and/or in the UE incorrectly detecting a data stall and inaccurately classifying a cell as a problematic cell.

Some techniques and apparatuses described herein enable application assisted uplink data stall detection and mitigation. For example, an application processor may indicate, to the modem, whether the application processor has detected an uplink data stall and an indication of a traffic service type (e.g., an application traffic type) that is currently being communicated via the application processor. The UE (e.g., the modem of the UE) may detect that one or more threshold criteria are satisfied for a serving cell using a threshold value associated with at least one of the one or more threshold criteria is based at least in part on the traffic service type. In other words, the values (e.g., the threshold values) used by the UE for detecting whether the one or more threshold criteria are satisfied may be specific to the traffic service type being communicated by the UE (e.g., as indicated by the application processor). The UE may transmit information associated with one or more adjusted measurement values of a serving cell based at least in part on detecting that the one or more threshold criteria are satisfied for the serving cell (e.g., using the threshold values that are associated with the traffic service type).

As a result, an accuracy associated with an uplink data stall detection by the UE may be improved. Therefore, the UE may more accurately apply mitigation mechanisms (such as applying a penalty to an RSRP reported in one or more measurement reports associated with the serving cell) for mitigating the effects of the uplink data stall. The UE may be transferred to another cell, thereby reducing a delay in data transfer and/or improving user experience, among other examples.

FIG. 4 is a diagram illustrating an example 400 associated with application assisted uplink data stall detection and mitigation, in accordance with the present disclosure. As shown in FIG. 4, a base station 110 and a UE 120 may communicate with one another in a wireless network, such as the wireless network 100. As shown in FIG. 4, a UE 120 may include various components for wireless communication, such as an application processor (AP) 405 and a modem 410, among other examples. The AP 405 may be a processor associated with processing traffic associated with applications executing on the UE 120. The modem 410 may be similar to the modems 254 described above (e.g., the modem 410 may perform operations associated with transmitting and receiving wireless communications, power management, and/or other operations).

As shown by reference number 415, the AP 405 may determine whether an uplink data stall has occurred. For example, the AP 405 may detect an uplink data stall based at least in part on one or more metrics of traffic associated with the AP 405. The one or more metrics may include a round-trip time (RTT) of packets associated with the traffic, a measured uplink throughput, a quantity of missed or dropped packets, and/or a rate of missed or dropped packets, among other examples. For example, if the one or more metrics satisfy one or more thresholds, then the AP 405 may determine that an uplink data stall has occurred. If the one or more metrics do not satisfy the threshold(s), then the AP 405 may determine that an uplink data stall has not occurred. In some aspects, the AP 405 may determine whether an uplink data stall has occurred during a particular time interval or time window (e.g., 2 seconds or another amount of time).

As shown by reference number 420, the AP 405 may transmit or provide, and the modem 410 may receive or obtain, an uplink (UL) data stall indication. The uplink data stall indication may include an indication of whether an uplink data stall has occurred. Additionally, the uplink data stall indication may include an indication of a traffic service type of traffic associated with the UE 120. For example, for each time interval, the AP 405 may determine whether an uplink data stall has occurred (e.g., during the time interval) and may determine a traffic service type of traffic being communicated via the AP 405 during the time interval. The traffic service type may include gaming traffic, video traffic, voice call traffic (e.g., voice over NR (VoNR) traffic), and/or internet traffic (e.g., website traffic), among other examples. Additionally, or alternatively, the traffic service type may include a mode of operation of the UE 120, such as a standalone mode or a dual connectivity mode, among other examples.

The uplink data stall indication may be a flag or other indication provided to the modem 410 by the AP 405. For example, a flag may be used to indicate whether an uplink data stall has occurred during a given time interval (e.g., an entry of “0” or “FALSE” in the flag may indicate that an uplink data stall has not occurred and a value of “1” or “TRUE” in the flag may indicate that an uplink data stall has occurred). The uplink data stall indication may also include an identifier associated with the traffic service type. The uplink data stall indication may assist the modem 410 in detecting and mitigating uplink data stalls because the AP 405 may provide information related to a current traffic service type and an indication of whether the AP 405 has detected an uplink data stall. This may enable the modem 410 to dynamically adapt operations used for uplink data stall detections and mitigation based at least in part on the traffic service type and/or whether the AP 405 has detected an uplink data stall, as described in more detail elsewhere herein, thereby improving an accuracy of uplink data stall detections by the modem 410.

As shown by reference number 425, the UE 120 (e.g., the modem 410) may detect whether one or more threshold criteria are satisfied for a serving cell. For example, for a particular time interval (e.g., 2 seconds), the UE 120 (e.g., the modem 410) may determine whether a threshold criteria satisfies a threshold value. A threshold value associated with at least one of the one or more threshold criteria may be based at least in part on the traffic service type. In other words, the UE 120 (e.g., the modem 410) may dynamically adapt the threshold value(s) used to evaluate the one or more threshold criteria based on the traffic service type (e.g., indicated by the AP 405, as described above). For example, for a first traffic service type, the UE 120 (e.g., the modem 410) may use a first threshold value to evaluate a first threshold criterion. For a second traffic service type, the UE 120 (e.g., the modem 410) may use a second threshold value to evaluate the first threshold criterion. This may improve an accuracy of a detection of an uplink data stall because different traffic service types may be associated with different traffic parameters. Therefore, using the same threshold value(s) for all traffic service types (e.g., in a “one size fits all” approach) may result in incorrect uplink data stall detections.

The one or more threshold criteria may include a first threshold criterion for an uplink grant rate, a second threshold criterion for a buffer size, a third threshold criterion for a packet data convergence protocol discard rate, a fourth threshold criterion for a serving cell reference signal received power, and/or a fifth threshold criterion for a power headroom, among other examples. For example, for a given time interval, the UE 120 (e.g., the modem 410) may determine whether the first threshold criterion of whether an uplink grant rate (e.g., a parameter ‘UL_GrantRate_bytes’), which represents a data rate in bytes of uplink grants over all logical channels and all uplink component carriers, satisfies a first threshold value (e.g., a parameter ‘Th_UL_Grant_lowerlimit’). Additionally, or alternatively, UE 120 may determine whether the second threshold criterion of whether a buffer size (e.g., a parameter ‘Sum_BufferSize’), which represents a sum of a buffer across all logical channels, satisfies a second threshold value (e.g., a parameter ‘Th_BufferSize_upperlimit’). Additionally, or alternatively, UE 120 may determine whether the third threshold criterion of a PDCP packet discard rate (e.g., a parameter ‘UL_PdcpDiscard_bytes’), which represents a data rate in bytes of PDCP discard, satisfies a third threshold (e.g., a threshold that is determined as a product of parameters ‘UL_GrantRate_bytes' and ‘Ratio_Discard2Grant’). The parameter ‘Ratio_Discard2Grant’ may represent a ratio of PDCP discards to uplink grants.

Additionally, or alternatively, UE 120 may determine whether the fourth threshold criterion of whether a serving cell RSRP on a primary component carrier (PCC) satisfies a fourth threshold (e.g., a parameter ‘Th_lowest_RSRP’), and whether a frequency tracking loop (FTL) signal to noise ratio (SNR) (FTLSNR) of the PCC satisfies a fifth threshold (e.g., a parameter ‘Th_lowest_FTLSNR’). Additionally, or alternatively, UE 120 may determine whether the fifth threshold criterion of a power headroom (PHR) satisfies a sixth threshold (e.g., a parameter ‘Th_PHR’). For example, UE 120 may determine, for each PCC physical uplink shared channel (PUSCH), a filtered PUSCH PHR based at least in part on an equation: Ph_avg(n)=Ph_avg(n−1)*0.9^{T/200 ms}+Ph(n)*(1−0.9^{T/200 ms}) where Ph_avg represents an average PUSCH PHR determined based at least in part on a PUSCH n. In some aspects, UE 120 may map the PUSCH PHR to an index value. For example, UE 120 may convert the PUSCH PHR to a decibel (dB) value and map the dB value to an index based at least in part on a set mapping, such as based at least in part on Table 9.1.8.4-1 in 3GPP Technical Specification (TS) 36.133, Release 17, Version 17.0.0. Additionally, or alternatively, UE 120 may determine the PHR based at least in part on a different PHR calculation procedure. Although some aspects are described in terms of determinations performed for a serving cell, as described below, UE 120 may perform the determinations described herein with regard to another cell, such as a neighbor cell.

As described above, the thresholds used by the UE 120 to evaluate the threshold criteria described herein may be specific to the traffic service type (e.g., indicated by the AP 405 for a given time interval). For example, the first threshold, the second threshold, the third threshold, the fourth threshold, the fifth threshold, and/or the sixth threshold may be based at least in part on the traffic service type (e.g., indicated by the AP 405). Additionally, or alternatively, the first threshold, the second threshold, the third threshold, the fourth threshold, the fifth threshold, and/or the sixth threshold may be based at least in part on a mode of operation of the UE 120 (e.g., standalone mode, dual connectivity mode, ENDC mode, NRDC mode, or another mode).

In some aspects, UE 120 may evaluate the one or more threshold criteria to classify a serving cell. For example, UE 120 may determine whether the first threshold criterion is satisfied; and at least one of the second threshold criterion or the third threshold criterion is satisfied; and the fourth threshold criterion is satisfied; and the fifth threshold criterion is satisfied. In such examples, UE 120 may classify the serving cell as a first type of cell, which may be termed a ‘doubtful cell’. As an example, at a first time, to, a set of criteria representing the aforementioned evaluation of the first through fifth threshold criterion are not satisfied, but at a second time, ti, the set of threshold criteria are satisfied and a serving cell is classified as a doubtful cell. In some aspects, UE 120 may classify the serving cell as a second type of cell, which may be termed a ‘problematic cell’ based at least in part on the set of threshold criteria being satisfied for a threshold quantity of time intervals (e.g., a parameter, ‘N_confirm’), such as a threshold of 3 consecutive time intervals.

For example, the UE 120 may determine that the set of threshold criteria are satisfied for time intervals t₃ through t₅ and may determine to classify the serving cell as a problematic cell. In some aspects, the threshold quantity of time intervals, N_confirm, may be based at least in part on a timestamp of when the serving cell was classified as a problematic cell. For example, if UE 120 determines that the serving cell is already added to a data structure storing information identifying problematic cells, as described below, and a timestamp for when the serving cell was added is within a threshold time interval, such as 2 hours, then the UE 120 may configure the threshold quantity of time intervals N_confirm as equal to N_confirm/2 or equal to a value of 1 (e.g., 1 time interval).

Additionally, or alternatively, the threshold quantity of time intervals, N_confirm, may be based at least in part on the uplink data stall indication from the AP 405. In other words, the UE 120 may detect that the one or more threshold criteria are satisfied for a first quantity of occurrences (e.g., a first value of N_confirm, such as 3) based at least in part on the indication from the AP 405, of whether the uplink data stall has occurred, indicating that no uplink data stall has occurred. The UE 120 may detect that the one or more threshold criteria are satisfied for a second quantity of occurrences (e.g., a second value of N_confirm, such as 1) based at least in part on the indication from the AP 405, of whether the uplink data stall has occurred, indicating that the uplink data stall has occurred. For example, if the uplink data stall indication indicates that the AP 405 detected an uplink data stall, then the UE 120 may configure the threshold quantity of time intervals N_confirm as equal to 1 (e.g., 1 time interval). Although some aspects are described in terms of a particular set of conditions, a particular combination of conditions, or a particular set of thresholds, among other examples, other parameters, conditions, combinations of conditions, or threshold are possible.

In some aspects, the UE 120 may store information regarding classifying the serving cell as a problematic cell. For example, the UE 120 may store information identifying an evolved universal mobile telecommunications system (UMTS) terrestrial radio access (E-UTRA) absolute radio frequency channel number (EARFCN), a physical layer cell identity (PCI), a timestamp representing when the serving cell was classified as a problematic cell, a flag indicating that the serving cell is currently classified as a problematic cell (e.g., which the UE 120 may update if the serving cell does not satisfy the set of criteria at a future time interval, such as after a parameter ‘T-_defavor’, which may be 5 minutes, is satisfied), or a penalty value, among other examples. The penalty value may represent an adjustment to an RSRP that is to be reported in a measurement report to enable triggering of an HO or RLF procedure in a reduced amount of time, as described above. For example, the UE 120 may apply a 3 dB penalty value for each time interval in which the serving cell is classified as a problematic cell (e.g., a 3 dB penalty at t₅, a 6 dB penalty at t₇, a 12 dB penalty at t₉, or a 15 dB penalty at t₁₀, among other examples). In some aspects, when incrementing the penalty (e.g., at t₇ relative to t₅), UE 120 may increment the penalty as a smaller value of the current penalty plus a step size (e.g., 3 dB) or a maximum penalty value (e.g., a parameter RSRP_dec_upperlimit), which may be 15 dB. When UE 120 updates the penalty value, UE 120 may update a timer for classifying whether the serving cell is a problematic cell. In some aspects, UE 120 may update a timestamp in a database of when the serving cell was classified as a problematic cell.

In some aspects, the UE 120 may evaluate the one or more threshold criteria to classify the serving cell based at least in part on the traffic service type. For example, the UE 120 may evaluate the one or more threshold criteria to classify the serving cell based at least in part on a quality of service (QoS) class identifier (QCI) of the traffic. For example, a QCI of 1 or 5 may indicate that the traffic is associated with voice call traffic (e.g., VoNR traffic). In such examples, the UE 120 may adjust the evaluation of the one or more threshold criteria to classify the serving cell based at least in part on the traffic being associated with voice call traffic (e.g., and the traffic being associated with a standalone mode). For example, the threshold value(s) used to determine whether the one or more threshold criteria are satisfied may be specific to voice call traffic. Additionally, which threshold criteria of the one or more threshold criteria need to be satisfied in order to classify a cell as doubtful cell or a problematic cell may be specific to voice call traffic (e.g., in a standalone mode).

For example, the traffic service type may be associated with setup signaling for a voice call (e.g., VoNR signaling) in a standalone mode. In such examples, detecting that the one or more threshold criteria are satisfied may include detecting that the first threshold criterion is satisfied using a first threshold value that is based at least in part on the traffic service type being setup signaling for a voice call; that the second threshold criterion is satisfied using a second threshold value that is based at least in part on the traffic service type being setup signaling for a voice call; and that the fourth threshold criterion is satisfied using a third threshold value that is based at least in part on the traffic service type being setup signaling for a voice call. If the above threshold criteria are satisfied, then the UE 120 may classify the serving cell as a doubtful cell. The UE 120 may classify the serving cell as a problematic cell in a similar manner as described above.

As another example, the traffic service type may be associated with an active voice call (e.g., VoNR media) in a standalone mode. In such examples, detecting that the one or more threshold criteria are satisfied may include detecting that a sixth threshold criterion for a quantity of uplink PDCP discarded packets (e.g., a parameter ‘UL_PdcpDiscard_Packets’) is satisfied using a threshold value that is based at least in part on the traffic service type being an active voice call (e.g., an active VoNR call) in the standalone mode; and detecting that the fourth threshold criterion is satisfied using a threshold value that is based at least in part on the traffic service type being an active voice call in the standalone mode. If the above threshold criteria are satisfied, then the UE 120 may classify the serving cell as a doubtful cell. The UE 120 may classify the serving cell as a problematic cell in a similar manner as described above.

As another example, the traffic service type may be associated with setup signaling for an evolved packet system fallback (EPSFB) voice call (e.g., a VoNR EPSFB call setup in the standalone mode). For example, the network (e.g., the base station 110) may not be capable of supporting VoNR, and thus may trigger fallback to LTE to attempt to set up the call using voice over LTE (VoLTE). A fallback from NR to LTE may be referred to as an EPSFB. In such examples, detecting that the one or more threshold criteria are satisfied may include detecting that the third threshold criterion (e.g., associated with the PDCP discard rate) is satisfied using a threshold value that is based at least in part on the traffic service type being setup signaling for an EPSFB voice call. If the above threshold criterion is satisfied, then the UE 120 may classify the serving cell as a doubtful cell. The UE 120 may classify the serving cell as a problematic cell in a similar manner as described above.

As another example, the traffic service type may be associated with a dual connectivity mode (e.g., an ENDC mode), where the UE 120 communicates using an NR RAT on an SCG. In such examples, detecting that the one or more threshold criteria are satisfied may include detecting that the first threshold criterion is satisfied using a first threshold value that is based at least in part on the traffic service type being associated with the dual connectivity mode; and at least one of the second threshold criterion (e.g., using a second threshold value that is based at least in part on the traffic service type being associated with the dual connectivity mode) or the third threshold criterion (e.g., using a third threshold value that is based at least in part on the traffic service type being associated with the dual connectivity mode) is satisfied; and the fifth threshold criterion is satisfied using a fourth threshold value that is based at least in part on the traffic service type being associated with the dual connectivity mode. If the above threshold criteria are satisfied, then the UE 120 may classify the serving cell as a doubtful cell. The UE 120 may classify the serving cell as a problematic cell in a similar manner as described above.

As shown by reference number 430, the UE 120 may perform one or more actions to mitigate the uplink data stall. For example, the UE 120 may perform the one or more actions based at least in part on the serving cell being classified as a problematic cell. In some aspects, as shown by reference number 435, the one or more actions may include transmitting (e.g., to the base station 110) information associated with one or more adjusted measurement values of the serving cell based at least in part on detecting that the one or more threshold criteria are satisfied (e.g., based at least in part on the serving cell being classified as a problematic cell). For example, the one or more adjusted measurement values may be derived by applying a penalty to an RSRP configuration of the serving cell. In other words, the UE 120 may measure an RSRP of the serving cell and may apply a penalty to the measured RSRP (e.g., may decrease a value of the measured RSRP by a penalty value) before reporting the measured RSRP to the base station. For example, the UE 120 may apply a 3 dB penalty value for each time interval in which the serving cell is classified as a problematic cell (e.g., a 3 dB penalty at a first time interval, a 6 dB penalty at a second time interval, a 12 dB penalty at a third time interval, or a 15 dB penalty at fourth time interval, among other examples).

As another example, the one or more actions may include adjusting a value for the N_confirm parameter. For example, if UE 120 determines that the serving cell is already added to a data structure storing information identifying problematic cells, as described below, and a timestamp for when the serving cell was added is within a threshold time interval, such as 2 hours, then the UE 120 may configure the threshold quantity of time intervals N_confirm as equal to N_confirm/2 or equal to a value of 1 (e.g., 1 time interval). The UE 120 may continue to apply the penalty value to measurements associated with the serving cell until an amount of time associated with the parameter ‘T_defavor’ expires.

In some aspects, the one or more actions performed by the UE 120 to mitigate the uplink data stall may be based at least in part on the traffic service type associated with the uplink data stall. For example, if the traffic service type is associated with a voice call (e.g., setup signaling, an active voice call, a VoNR voice call, and/or an EPSFB voice call), then the one or more actions may include performing an action to bar a serving cell for a threshold amount of time (e.g., 1 second or another amount of time) based at least in part on detecting that the one or more threshold criteria are satisfied. As another example, if the traffic service type is associated with a voice call, then the one or more actions may include triggering an RLF (e.g., based at least in part on transmitting the information identifying the one or more adjusted measurement values).

As another example, if the traffic service type is associated with a voice call, then the one or more actions may include triggering an RLF with a serving cell based at least in part on the one or more signal strengths of the one or more neighbor cells not being within a threshold amount of the one or more adjusted measurement values. For example, the UE 120 may measure one or more signal strengths of one or more neighbor cells. If, after applying a maximum penalty value (e.g., 6 dB or another maximum penalty value) to the measured RSRP values of the serving cell, the UE 120 determines that signal strengths (e.g., the RSRP values) of the one or more neighbor cells are not within the threshold amount of the one or more adjusted measurement values (e.g., adjusted using the maximum penalty value), then the UE 120 may trigger an RLF. The threshold amount may be based at least in part on a value of a measurement value of the serving cell (e.g., prior to applying the penalty value). For example, if the RSRP of the serving cell is greater than −80 decibel-milliwatts (dBm), then the threshold value may be 30 dB. If the RSRP of the serving cell is less than or equal to −80 dBm and greater than or equal to −100 dBm, then the threshold value may be 20 dB. If the RSRP of the serving cell is less than −100 dBm, then the threshold value may be 15 dB. The above threshold values are provided as examples and other threshold values (for the same, similar, or different serving cell RSRP values) are possible.

In some aspects, the one or more actions may include redirecting a connection of the UE 120 to a different RAT. For example, if the traffic service type is associated with an EPSFB voice call (e.g., a VoNR EPSFB voice call) associated with a first RAT (e.g., NR), then the one or more actions may include performing, based at least in part on detecting that the one or more threshold criteria are satisfied, an action for a redirection to establish a connection using a second RAT (e.g., LTE) based at least in part on a measurement configuration (e.g., received from the base station 110) not configuring the UE 120 to perform measurements associated with inter-RAT neighbor cells (e.g., based at least in part on the base station 110 not configuring the UE 120 to perform any measurements for transitioning from the first RAT to the second RAT, such as NR to LTE (N2L) measurements). Additionally, or alternatively, the UE 120 may perform, based at least in part on detecting that the one or more threshold criteria are satisfied, an action for a redirection to establish a connection using a second RAT (e.g., LTE) based at least in part on the base station 110 configuring measurements for transitioning from the first RAT to the second RAT, but a measurement event not being satisfied. For example, the measurement event may be associated with triggering a transition (e.g., a redirection) from the first RAT to the second RAT. As an example, the measurement event may be a B1 or B2 measurement event (e.g., as defined, or otherwise fixed, by a wireless communication standard, such as the 3GPP). In other words, the UE 120 may trigger a blind redirection to the second RAT (e.g., a blind N2L redirection) based at least in part on the base station 110 not configuring any N2L measurements or based at least in part on the base station 110 configuring N2L measurements but a B1 or B2 measurement event not being met or satisfied. “Blind redirection” may refer to the UE 120 triggering a transition to another RAT without a condition or event for transitioning to the other RAT having been met or satisfied.

In some aspects, the one or more actions may be based at least in part on whether the traffic is associated with an SCG primary path or an SCG secondary path. The SCG primary path may be the primary path for a split radio bearer. For example, a DRB may be split on the uplink with a primary path to the MCG or the SCG. If the SCG is the primary path, then the one or more actions may be similar to the one or more actions described above in connection with voice calls. In some aspects, threshold values and/or a maximum penalty value may be different when the traffic service type is associated with an SCG that is the primary path (e.g., as compared to when the traffic service type is associated with a voice call). For example, the one or more actions may include triggering an RLF associated with the SCG based at least in part on a handover associated with the SCG not being triggered and a value of the penalty satisfying a first threshold (e.g., 15 dB or another value). As another example, the one or more actions may include triggering the radio link failure associated with the SCG based at least in part on measurements of one or more neighbor cells not being within a threshold amount of the one or more adjusted measurement values and the value of the penalty satisfying a second threshold (e.g., 12 dB or another value), in a similar manner as described elsewhere herein. In other words, the UE 120 may perform the one or more actions described herein to mitigate the uplink data stall based at least in part on the SCG being the primary path.

If the UE 120 determines that the SCG is a secondary path, then the UE 120 may refrain from performing the one or more actions described herein to mitigate the uplink data stall based at least in part on the SCG being the secondary path. This may enable the UE 120 to maintain a connection with the SCG because the cell associated with the uplink data stall may be associated with a secondary path and the primary path of the SCG may not be associated with an uplink data stall.

In some aspects, the traffic service type and/or the detected uplink data stall may be associated with a first connection (e.g., a first leg) associated with a dual connectivity mode (e.g., an ENDC mode, an NRDC mode, or another dual connectivity mode). In such examples, the one or more actions may include refraining from transmitting data via the first connection. The UE 120 may transmit the data via a second connection (e.g., a second leg) associated with the dual connectivity mode based at least in part on detecting that the one or more threshold criteria are satisfied (e.g., based at least in part on detecting the uplink data stall associated with the first connection or the first leg). This may enable the UE 120 to transmit the uplink data with a reduced delay, thereby improving uplink throughput and reducing latency.

In some aspects, based at least in part on performing the one or more actions and/or transmitting the adjusted measurement values, the UE 120 may establish a new connection via a second RAT (e.g., a different RAT than a first RAT associated with the connection that experienced the uplink data stall). However, the penalty values and/or other actions associated with mitigating the uplink data stall may be associated with the first RAT. Therefore, because the action(s) and/or penalties may no longer be applied when the UE 120 transitions to the second RAT, the UE 120 may measure the previous serving cell, may not perform the actions and/or penalty, and may trigger to a handover or redirection back to the previous serving cell. As the previous serving cell may be a problematic cell (e.g., associated with an uplink data stall), then UE 120 may then resume performing the action(s) and/or applying the penalty, resulting in the UE 120 transitioning back the connection associated with the second RAT. As a result, a “ping-pong” effect may be experienced by the UE 120 associated with transitioning back and forth between the first RAT and the second RAT. To mitigate the aforementioned scenario, the UE 120 may continue to perform the action(s) and/or apply the penalty to cells identified in a database or data store as problematic cells (e.g., even after transitioning to the second RAT). For example, the UE 120 may transmit information associated with inter-RAT measurements from the second RAT to the first RAT based at least in part on applying the penalty to a second RSRP of a cell (e.g., a problematic cell) associated with the second RAT. In other words, the information in the database associated with identifying problematic cells may be applied in the second RAT when the UE 120 is performing cell resection measurements and/or B1 or B2 measurement event evaluations. This may reduce a likelihood that the UE 120 will transmit measurement information that causes the UE 120 to reselect to and/or hand over to a problematic cell that was previously identified when communicating via the first RAT. As a result, the use of stored information with the first RAT when communicating via second RAT may improve uplink data stall mitigation. In some aspects, the first RAT may be the NR RAT and the second RAT may be the LTE RAT.

In some aspects, the base station 110 may determine to transfer or hand over the UE 120 to a new cell. For example, the base station 110 may determine to transfer or hand over the UE 120 to a new cell based at least in part on the one or more actions performed by the UE 120, the measurement report including the adjusted measurement value(s), and/or the UE 120 triggering an RLF, among other examples. For example, the base station 110 may initiate a handover procedure for the UE 120 to enable the UE 120 to establish a connection with a new cell.

As a result, an accuracy associated with an uplink data stall detection by the UE 120 may be improved. Therefore, the UE 120 may more accurately apply mitigation mechanisms (such as applying a penalty to an RSRP reported in one or more measurement reports associated with the serving cell) for mitigating the effects of the uplink data stall. The UE 120 may be transferred to another cell, thereby reducing a delay in data transfer and/or improving user experience, among other examples.

As indicated above, FIG. 4 is provided as an example. Other examples may differ from what is described with respect to FIG. 4

FIG. 5 is a diagram illustrating an example process 500 performed, for example, by a UE, in accordance with the present disclosure. Example process 500 is an example where the UE (e.g., UE 120) performs operations associated with application assisted uplink data stall detection and mitigation.

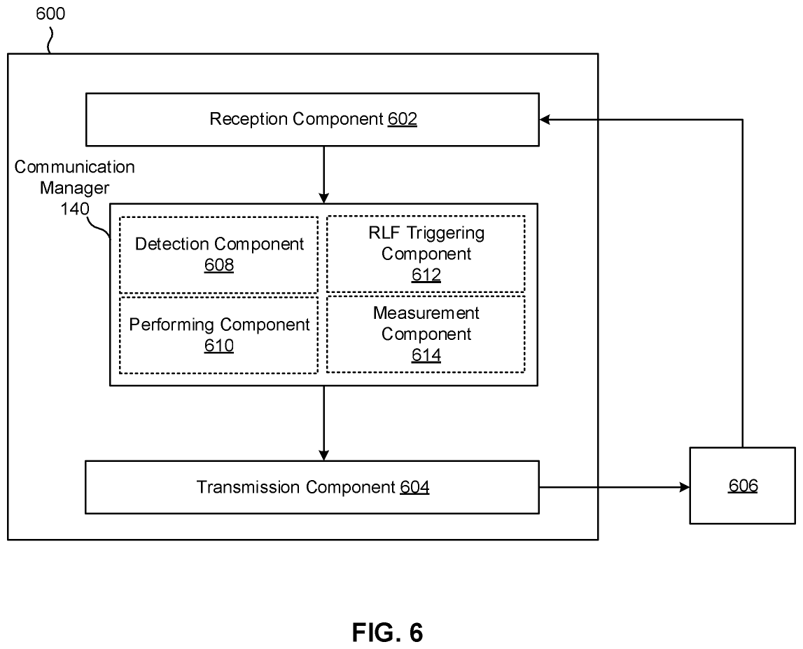

As shown in FIG. 5, in some aspects, process 500 may include receiving, from an application processor associated with the UE, an indication of a traffic service type and whether an uplink data stall has occurred (block 510). For example, the UE (e.g., using communication manager 140 and/or reception component 602, depicted in FIG. 6) may receive, from an application processor associated with the UE, an indication of a traffic service type and whether an uplink data stall has occurred, as described above.

As further shown in FIG. 5, in some aspects, process 500 may include detecting that one or more threshold criteria are satisfied for a serving cell, wherein a threshold value associated with at least one of the one or more threshold criteria is based at least in part on the traffic service type (block 520). For example, the UE (e.g., using communication manager 140 and/or detection component 608, depicted in FIG. 6) may detect that one or more threshold criteria are satisfied for a serving cell, wherein a threshold value associated with at least one of the one or more threshold criteria is based at least in part on the traffic service type, as described above.

As further shown in FIG. 5, in some aspects, process 500 may include transmitting information associated with one or more adjusted measurement values of the serving cell based at least in part on detecting that the one or more threshold criteria are satisfied (block 530). For example, the UE (e.g., using communication manager 140 and/or transmission component 604, depicted in FIG. 6) may transmit information associated with one or more adjusted measurement values of the serving cell based at least in part on detecting that the one or more threshold criteria are satisfied, as described above.

Process 500 may include additional aspects, such as any single aspect or any combination of aspects described below and/or in connection with one or more other processes described elsewhere herein.

In a first aspect, the one or more threshold criteria include at least one of a first threshold criterion for an uplink grant rate, a second threshold criterion for a buffer size, a third threshold criterion for a packet data convergence protocol discard rate, a fourth threshold criterion for a serving cell reference signal received power, or a fifth threshold criterion for a power headroom.

In a second aspect, alone or in combination with the first aspect, the traffic service type is associated with setup signaling for a voice call in a standalone mode, and wherein detecting that the one or more threshold criteria are satisfied comprises detecting that a first threshold criterion for an uplink grant rate is satisfied using a first threshold value that is based at least in part on the traffic service type, detecting that a second threshold criterion for a buffer size is satisfied using a second threshold value that is based at least in part on the traffic service type, and detecting that a third threshold criterion for a serving cell reference signal received power is satisfied using a third threshold value that is based at least in part on the traffic service type.

In a third aspect, alone or in combination with one or more of the first and second aspects, the traffic service type is associated with an active voice call in a standalone mode, and wherein detecting that the one or more threshold criteria are satisfied comprises detecting that a first threshold criterion for a quantity of packet data convergence protocol discarded packets is satisfied using a first threshold value that is based at least in part on the traffic service type, and detecting that a second threshold criterion for a serving cell reference signal received power is satisfied using a second threshold value that is based at least in part on the traffic service type.

In a fourth aspect, alone or in combination with one or more of the first through third aspects, detecting that the one or more threshold criteria are satisfied comprises detecting that the one or more threshold criteria are satisfied for a first quantity of occurrences based at least in part on the indication from the application processor, of whether the uplink data stall has occurred, indicating that no uplink data stall has occurred, or detecting that the one or more threshold criteria are satisfied for a second quantity of occurrences based at least in part on the indication from the application processor, of whether the uplink data stall has occurred, indicating that the uplink data stall has occurred.

In a fifth aspect, alone or in combination with one or more of the first through fourth aspects, the one or more adjusted measurement values are derived by applying a penalty to a reference signal received power configuration.

In a sixth aspect, alone or in combination with one or more of the first through fifth aspects, process 500 includes performing an action to bar a serving cell for a threshold amount of time based at least in part on detecting that the one or more threshold criteria are satisfied.

In a seventh aspect, alone or in combination with one or more of the first through sixth aspects, process 500 includes triggering a radio link failure based at least in part on transmitting the information identifying the one or more adjusted measurement values.

In an eighth aspect, alone or in combination with one or more of the first through seventh aspects, process 500 includes measuring one or more signal strengths of one or more neighbor cells, and triggering a radio link failure with a serving cell based at least in part on the one or more signal strengths of the one or more neighbor cells not being within a threshold amount of the one or more adjusted measurement values.

In a ninth aspect, alone or in combination with one or more of the first through eighth aspects, the threshold amount is based at least in part on a value of a measurement value of the serving cell.

In a tenth aspect, alone or in combination with one or more of the first through ninth aspects, the traffic service type is associated with setup signaling for an EPSFB voice call, and detecting that the one or more threshold criteria are satisfied comprises detecting that a first threshold criterion for a packet data convergence protocol discard rate is satisfied using a first threshold value that is based at least in part on the traffic service type.

In an eleventh aspect, alone or in combination with one or more of the first through tenth aspects, the traffic service type is associated with setup signaling for an EPSFB voice call, wherein the EPSFB voice call is associated with a first RAT, and process 500 includes performing, based at least in part on detecting that the one or more threshold criteria are satisfied, an action for a redirection to establish a connection using a second RAT based at least in part on at least one of a measurement configuration not configuring the UE to perform measurements associated with inter-RAT neighbor cells, or a measurement event not being satisfied, wherein the measurement event is indicated by the measurement configuration and associated with redirecting to neighbor cells associated with the second RAT.

In a twelfth aspect, alone or in combination with one or more of the first through eleventh aspects, the traffic service type is associated with an SCG in a dual connectivity mode, and detecting that the one or more threshold criteria are satisfied comprises detecting that a first threshold criterion for an uplink grant rate is satisfied using a first threshold value that is based at least in part on the traffic service type, detecting that a second threshold criterion for a buffer size is satisfied using a second threshold value that is based at least in part on the traffic service type or that a third threshold criterion for a packet data convergence protocol discard rate packets is satisfied using a third threshold value that is based at least in part on the traffic service type, and detecting that a fourth threshold criterion for a serving cell reference signal received power is satisfied using a fourth threshold value that is based at least in part on the traffic service type.

In a thirteenth aspect, alone or in combination with one or more of the first through twelfth aspects, the traffic service type is associated with an SCG in a dual connectivity mode, wherein the SCG is a primary path associated with the dual connectivity mode, and process 500 includes performing one or more actions to mitigate the uplink data stall based at least in part on the SCG being the primary path.

In a fourteenth aspect, alone or in combination with one or more of the first through thirteenth aspects, the one or more actions include at least one of applying a penalty to a reference signal received power configuration associated with the SCG, triggering a radio link failure associated with the SCG based at least in part on a handover associated with the SCG not being triggered and a value of the penalty satisfying a first threshold, or triggering the radio link failure associated with the SCG based at least in part on measurements of one or more neighbor cells not being within a threshold amount of the one or more adjusted measurement values and the value of the penalty satisfying a second threshold.

In a fifteenth aspect, alone or in combination with one or more of the first through fourteenth aspects, the traffic service type is associated with an SCG in a dual connectivity mode, the SCG is a secondary path associated with the dual connectivity mode, and process 500 includes refraining from performing one or more actions to mitigate the uplink data stall based at least in part on the SCG being the secondary path.

In a sixteenth aspect, alone or in combination with one or more of the first through fifteenth aspects, the traffic service type is associated with a first connection associated with a dual connectivity mode, and process 500 includes refraining from transmitting data via the first connection, and transmitting the data via a second connection associated with the dual connectivity mode based at least in part on detecting that the one or more threshold criteria are satisfied.

In a seventeenth aspect, alone or in combination with one or more of the first through sixteenth aspects, the one or more adjusted measurement values are derived by applying a penalty to a first reference signal received power configuration of a cell associated with a first RAT, and process 500 includes establishing a connection via a second RAT, and transmitting information associated with inter-RAT measurements from the second RAT to the first RAT based at least in part on applying the penalty to a second reference signal received power configuration of the cell associated with the second RAT.

In an eighteenth aspect, alone or in combination with one or more of the first through seventeenth aspects, process 500 includes detecting, by the application processor, the uplink data stall based at least in part on one or more metrics of traffic associated with the application processor.

In a nineteenth aspect, alone or in combination with one or more of the first through eighteenth aspects, the traffic service type includes at least one of gaming traffic, video traffic, voicing call traffic, or internet traffic.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication. The apparatus 600 may be a UE, or a UE may include the apparatus 600. In some aspects, the apparatus 600 includes a reception component 602 and a transmission component 604, which may be in communication with one another (for example, via one or more buses and/or one or more other components). As shown, the apparatus 600 may communicate with another apparatus 606 (such as a UE, a base station, or another wireless communication device) using the reception component 602 and the transmission component 604. As further shown, the apparatus 600 may include the communication manager 140. The communication manager 140 may include one or more of a detection component 608, a performing component 610, an RLF triggering component 612, and/or a measurement component 614, among other examples.

In some aspects, the apparatus 600 may be configured to perform one or more operations described herein in connection with FIG. 4. Additionally, or alternatively, the apparatus 600 may be configured to perform one or more processes described herein, such as process 500 of FIG. 5, or a combination thereof. In some aspects, the apparatus 600 and/or one or more components shown in FIG. 6 may include one or more components of the UE described in connection with FIG. 2. Additionally, or alternatively, one or more components shown in FIG. 6 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 602 may receive communications, such as reference signals, control information, data communications, or a combination thereof, from the apparatus 606. The reception component 602 may provide received communications to one or more other components of the apparatus 600. In some aspects, the reception component 602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 600. In some aspects, the reception component 602 may include one or more antennas, a modem, a demodulator, a MIMO detector, a receive processor, a controller/processor, a memory, or a combination thereof, of the UE described in connection with FIG. 2.

The transmission component 604 may transmit communications, such as reference signals, control information, data communications, or a combination thereof, to the apparatus 606. In some aspects, one or more other components of the apparatus 600 may generate communications and may provide the generated communications to the transmission component 604 for transmission to the apparatus 606. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 606. In some aspects, the transmission component 604 may include one or more antennas, a modem, a modulator, a transmit MIMO processor, a transmit processor, a controller/processor, a memory, or a combination thereof, of the UE described in connection with FIG. 2. In some aspects, the transmission component 604 may be co-located with the reception component 602 in a transceiver.

The reception component 602 may receive, from an application processor associated with the UE, an indication of a traffic service type and whether an uplink data stall has occurred. The detection component 608 may detect that one or more threshold criteria are satisfied for a serving cell, wherein a threshold value associated with at least one of the one or more threshold criteria is based at least in part on the traffic service type. The transmission component 604 may transmit information associated with one or more adjusted measurement values of the serving cell based at least in part on detecting that the one or more threshold criteria are satisfied.

The performing component 610 may perform an action to bar a serving cell for a threshold amount of time based at least in part on detecting that the one or more threshold criteria are satisfied.

The RLF triggering component 612 may trigger an RLF based at least in part on transmitting the information identifying the one or more adjusted measurement values.

The measurement component 614 may measure one or more signal strengths of one or more neighbor cells.

The RLF triggering component 612 may trigger an RLF with a serving cell based at least in part on the one or more signal strengths of the one or more neighbor cells not being within a threshold amount of the one or more adjusted measurement values.

The detection component 608 may detect the uplink data stall based at least in part on one or more metrics of traffic associated with the application processor.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

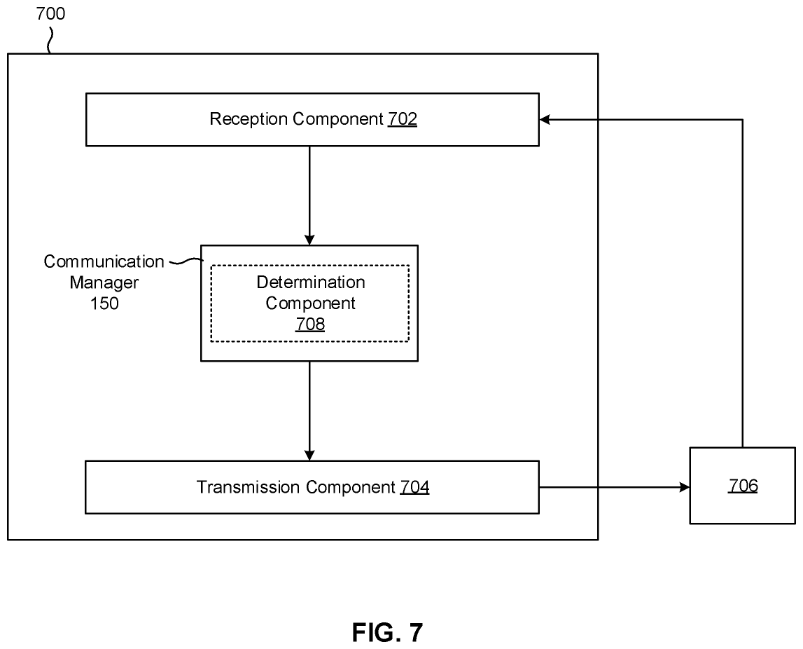

FIG. 7 is a diagram of an example apparatus 700 for wireless communication. The apparatus 700 may be a base station, or a base station may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include the communication manager 150. The communication manager 150 may include one or more of a determination component 708, among other examples.

In some aspects, the apparatus 700 may be configured to perform one or more operations described herein in connection with FIG. 4. Additionally, or alternatively, the apparatus 700 may be configured to perform one or more processes described herein. In some aspects, the apparatus 700 and/or one or more components shown in FIG. 7 may include one or more components of the base station described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the base station described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the base station described in connection with FIG. 2. In some aspects, the transmission component 704 may be co-located with the reception component 702 in a transceiver.

The reception component 702 may receive, from a UE, information associated with one or more adjusted measurement values of a serving cell (e.g., in a measurement report). The determination component 708 may determine whether to transfer or hand over the UE to another cell. The transmission component 704 may transmit information to cause the UE to be transferred to another cell (e.g., based at least in part on determining to transfer or hand over the UE to the other cell).

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a user equipment (UE), comprising: receiving, by a modem of the UE and from an application processor associated with the UE, an indication of a traffic service type and whether an uplink data stall has occurred; detecting that one or more threshold criteria are satisfied for a serving cell, wherein a threshold value associated with at least one of the one or more threshold criteria is based at least in part on the traffic service type; and transmitting information associated with one or more adjusted measurement values of the serving cell based at least in part on detecting that the one or more threshold criteria are satisfied.

Aspect 2: The method of Aspect 1, wherein the one or more threshold criteria include at least one of: a first threshold criterion for an uplink grant rate, a second threshold criterion for a buffer size, a third threshold criterion for a packet data convergence protocol discard rate, a fourth threshold criterion for a serving cell reference signal received power, or a fifth threshold criterion for a power headroom.

Aspect 3: The method of any of Aspects 1-2, wherein the traffic service type is associated with setup signaling for a voice call in a standalone mode, and wherein detecting that the one or more threshold criteria are satisfied comprises: detecting that a first threshold criterion for an uplink grant rate is satisfied using a first threshold value that is based at least in part on the traffic service type; detecting that a second threshold criterion for a buffer size is satisfied using a second threshold value that is based at least in part on the traffic service type; and detecting that a third threshold criterion for a serving cell reference signal received power is satisfied using a third threshold value that is based at least in part on the traffic service type.

Aspect 4: The method of any of Aspects 1-2, wherein the traffic service type is associated with an active voice call in a standalone mode, and wherein detecting that the one or more threshold criteria are satisfied comprises: detecting that a first threshold criterion for a quantity of packet data convergence protocol discarded packets is satisfied using a first threshold value that is based at least in part on the traffic service type; and detecting that a second threshold criterion for a serving cell reference signal received power is satisfied using a second threshold value that is based at least in part on the traffic service type.

Aspect 5: The method of any of Aspects 1-4, wherein detecting that the one or more threshold criteria are satisfied comprises: detecting that the one or more threshold criteria are satisfied for a first quantity of occurrences based at least in part on the indication from the application processor, of whether the uplink data stall has occurred, indicating that no uplink data stall has occurred; or detecting that the one or more threshold criteria are satisfied for a second quantity of occurrences based at least in part on the indication from the application processor, of whether the uplink data stall has occurred, indicating that the uplink data stall has occurred.

Aspect 6: The method of any of Aspects 1-5, wherein the one or more adjusted measurement values are derived by applying a penalty to a reference signal received power configuration.

Aspect 7: The method of any of Aspects 1-6, further comprising: performing an action to bar a serving cell for a threshold amount of time based at least in part on detecting that the one or more threshold criteria are satisfied.

Aspect 8: The method of any of Aspects 1-7, further comprising: triggering a radio link failure based at least in part on transmitting the information identifying the one or more adjusted measurement values.

Aspect 9: The method of any of Aspects 1-8, further comprising: measuring one or more signal strengths of one or more neighbor cells; and triggering a radio link failure with a serving cell based at least in part on the one or more signal strengths of the one or more neighbor cells not being within a threshold amount of the one or more adjusted measurement values.

Aspect 10: The method of Aspect 9, wherein the threshold amount is based at least in part on a value of a measurement value of the serving cell.

Aspect 11: The method of any of Aspects 1-2 and 5-10, wherein the traffic service type is associated with setup signaling for an evolved packet system fallback (EPSFB) voice call, and wherein detecting that the one or more threshold criteria are satisfied comprises: detecting that a first threshold criterion for a packet data convergence protocol discard rate is satisfied using a first threshold value that is based at least in part on the traffic service type.

Aspect 12: The method of any of Aspects 1-2 and 5-11, wherein the traffic service type is associated with setup signaling for an evolved packet system fallback (EPSFB) voice call, wherein the EPSFB voice call is associated with a first radio access technology (RAT), the method further comprising: performing, based at least in part on detecting that the one or more threshold criteria are satisfied, an action for a redirection to establish a connection using a second RAT based at least in part on at least one of: a measurement configuration not configuring the UE to perform measurements associated with inter-RAT neighbor cells, or a measurement event not being satisfied, wherein the measurement event is indicated by the measurement configuration and associated with redirecting to neighbor cells associated with the second RAT.

Aspect 13: The method of any of Aspects 1-12, wherein the traffic service type is associated with a secondary cell group (SCG) in a dual connectivity mode, and wherein detecting that the one or more threshold criteria are satisfied comprises: detecting that a first threshold criterion for an uplink grant rate is satisfied using a first threshold value that is based at least in part on the traffic service type; detecting that a second threshold criterion for a buffer size is satisfied using a second threshold value that is based at least in part on the traffic service type or that a third threshold criterion for a packet data convergence protocol discard rate packets is satisfied using a third threshold value that is based at least in part on the traffic service type; and detecting that a fourth threshold criterion for a serving cell reference signal received power is satisfied using a fourth threshold value that is based at least in part on the traffic service type.

Aspect 14: The method of any of Aspects 1-13, wherein the traffic service type is associated with a secondary cell group (SCG) in a dual connectivity mode, wherein the SCG is a primary path associated with the dual connectivity mode, and the method further comprising: performing one or more actions to mitigate the uplink data stall based at least in part on the SCG being the primary path.

Aspect 15: The method of Aspect 14, wherein the one or more actions include at least one of: applying a penalty to a reference signal received power configuration associated with the SCG; triggering a radio link failure associated with the SCG based at least in part on a handover associated with the SCG not being triggered and a value of the penalty satisfying a first threshold; or triggering the radio link failure associated with the SCG based at least in part on measurements of one or more neighbor cells not being within a threshold amount of the one or more adjusted measurement values and the value of the penalty satisfying a second threshold.

Aspect 16: The method of any of Aspects 1-13, wherein the traffic service type is associated with a secondary cell group (SCG) in a dual connectivity mode, wherein the SCG is a secondary path associated with the dual connectivity mode, and the method further comprising: refraining from performing one or more actions to mitigate the uplink data stall based at least in part on the SCG being the secondary path.

Aspect 17: The method of any of Aspects 1-16, wherein the traffic service type is associated with a first connection associated with a dual connectivity mode, and the method further comprising: refraining from transmitting data via the first connection; and transmitting the data via a second connection associated with the dual connectivity mode based at least in part on detecting that the one or more threshold criteria are satisfied.

Aspect 18: The method of any of Aspects 1-17, wherein the one or more adjusted measurement values are derived by applying a penalty to a first reference signal received power configuration of a cell associated with a first radio access technology (RAT), and the method further comprising: establishing a connection via a second RAT; and transmitting information associated with inter-RAT measurements from the second RAT to the first RAT based at least in part on applying the penalty to a second reference signal received power configuration of the cell associated with the second RAT.

Aspect 19: The method of any of Aspects 1-18, further comprising: detecting, by the application processor, the uplink data stall based at least in part on one or more metrics of traffic associated with the application processor.

Aspect 20: The method of any of Aspects 1-19, wherein the traffic service type includes at least one of: gaming traffic, video traffic, voice call traffic, or internet traffic.

Aspect 21: An apparatus for wireless communication at a device, comprising a processor; memory coupled with the processor; and instructions stored in the memory and executable by the processor to cause the apparatus to perform the method of one or more of Aspects 1-20.

Aspect 22: A device for wireless communication, comprising a memory and one or more processors coupled to the memory, the one or more processors configured to perform the method of one or more of Aspects 1-20.

Aspect 23: An apparatus for wireless communication, comprising at least one means for performing the method of one or more of Aspects 1-20.

Aspect 24: A non-transitory computer-readable medium storing code for wireless communication, the code comprising instructions executable by a processor to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving, by a modem of the UE and from an application processor associated with the UE, an indication of a traffic service type and whether an uplink data stall has occurred;
detecting that one or more threshold criteria are satisfied for a serving cell, wherein a threshold value associated with at least one of the one or more threshold criteria is based at least in part on the traffic service type; and
transmitting information associated with one or more adjusted measurement values of the serving cell based at least in part on detecting that the one or more threshold criteria are satisfied.

2. The method of claim 1, wherein the traffic service type is associated with setup signaling for a voice call in a standalone mode, and wherein detecting that the one or more threshold criteria are satisfied comprises:
detecting that a first threshold criterion for an uplink grant rate is satisfied using a first threshold value that is based at least in part on the traffic service type;
detecting that a second threshold criterion for a buffer size is satisfied using a second threshold value that is based at least in part on the traffic service type; and
detecting that a third threshold criterion for a serving cell reference signal received power is satisfied using a third threshold value that is based at least in part on the traffic service type.

3. The method of claim 1, wherein the traffic service type is associated with an active voice call in a standalone mode, and wherein detecting that the one or more threshold criteria are satisfied comprises:
detecting that a first threshold criterion for a quantity of packet data convergence protocol discarded packets is satisfied using a first threshold value that is based at least in part on the traffic service type; and
detecting that a second threshold criterion for a serving cell reference signal received power is satisfied using a second threshold value that is based at least in part on the traffic service type.

4. The method of claim 1, wherein detecting that the one or more threshold criteria are satisfied comprises:
detecting that the one or more threshold criteria are satisfied for a first quantity of occurrences based at least in part on the indication from the application processor, of whether the uplink data stall has occurred, indicating that no uplink data stall has occurred; or
detecting that the one or more threshold criteria are satisfied for a second quantity of occurrences based at least in part on the indication from the application processor, of whether the uplink data stall has occurred, indicating that the uplink data stall has occurred.

5. The method of claim 1, further comprising:
measuring one or more signal strengths of one or more neighbor cells; and
triggering a radio link failure with a serving cell based at least in part on the one or more signal strengths of the one or more neighbor cells not being within a threshold amount of the one or more adjusted measurement values.

6. The method of claim 1, wherein the traffic service type is associated with setup signaling for an evolved packet system fallback (EPSFB) voice call, and wherein detecting that the one or more threshold criteria are satisfied comprises:
detecting that a first threshold criterion for a packet data convergence protocol discard rate is satisfied using a first threshold value that is based at least in part on the traffic service type.

7. The method of claim 1, wherein the traffic service type is associated with setup signaling for an evolved packet system fallback (EPSFB) voice call, wherein the EPSFB voice call is associated with a first radio access technology (RAT), the method further comprising:
performing, based at least in part on detecting that the one or more threshold criteria are satisfied, an action for a redirection to establish a connection using a second RAT based at least in part on at least one of:
a measurement configuration not configuring the UE to perform measurements associated with inter-RAT neighbor cells, or
a measurement event not being satisfied, wherein the measurement event is indicated by the measurement configuration and associated with redirecting to neighbor cells associated with the second RAT.

8. The method of claim 1, wherein the traffic service type is associated with a secondary cell group (SCG) in a dual connectivity mode, wherein the SCG is a primary path associated with the dual connectivity mode, the method further comprising:
performing one or more actions to mitigate the uplink data stall based at least in part on the SCG being the primary path.

9. The method of claim 8, wherein the one or more actions include at least one of:
applying a penalty to a reference signal received power configuration associated with the SCG;
triggering a radio link failure associated with the SCG based at least in part on a handover associated with the SCG not being triggered and a value of the penalty satisfying a first threshold; or
triggering the radio link failure associated with the SCG based at least in part on measurements of one or more neighbor cells not being within a threshold amount of the one or more adjusted measurement values and the value of the penalty satisfying a second threshold.

10. The method of claim 1, wherein the traffic service type is associated with a secondary cell group (SCG) in a dual connectivity mode, wherein the SCG is a secondary path associated with the dual connectivity mode, the method further comprising:
refraining from performing one or more actions to mitigate the uplink data stall based at least in part on the SCG being the secondary path.

11. The method of claim 1, wherein the traffic service type is associated with a first connection associated with a dual connectivity mode, the method further comprising:
refraining from transmitting data via the first connection; and
transmitting the data via a second connection associated with the dual connectivity mode based at least in part on detecting that the one or more threshold criteria are satisfied.

12. The method of claim 1, wherein the one or more adjusted measurement values are derived by applying a penalty to a first reference signal received power configuration of a cell associated with a first radio access technology (RAT), the method further comprising:
establishing a connection via a second RAT; and
transmitting information associated with inter-RAT measurements from the second RAT to the first RAT based at least in part on applying the penalty to a second reference signal received power configuration of the cell associated with the second RAT.

13. The method of claim 1, further comprising:
detecting, by the application processor, the uplink data stall based at least in part on one or more metrics of traffic associated with the application processor.

14. The method of claim 1, wherein the traffic service type includes at least one of:
gaming traffic,
video traffic,
voice call traffic, or
internet traffic.

15. A user equipment (UE) for wireless communication, comprising:
a memory; and
one or more processors, coupled to the memory, configured to:
receive, from an application processor associated with the UE, an indication of a traffic service type and whether an uplink data stall has occurred;
detect that one or more threshold criteria are satisfied for a serving cell, wherein a threshold value associated with at least one of the one or more threshold criteria is based at least in part on the traffic service type; and
transmit information associated with one or more adjusted measurement values of the serving cell based at least in part on detecting that the one or more threshold criteria are satisfied.

16. The UE of claim 15, wherein the traffic service type is associated with setup signaling for a voice call in a standalone mode, and wherein the one or more processors, to detect that the one or more threshold criteria are satisfied, are configured to:
detect that a first threshold criterion for an uplink grant rate is satisfied using a first threshold value that is based at least in part on the traffic service type;
detect that a second threshold criterion for a buffer size is satisfied using a second threshold value that is based at least in part on the traffic service type; and
detect that a third threshold criterion for a serving cell reference signal received power is satisfied using a third threshold value that is based at least in part on the traffic service type.

17. The UE of claim 15, wherein the traffic service type is associated with an active voice call in a standalone mode, and wherein the one or more processors, to detect that the one or more threshold criteria are satisfied, are configured to:
detect that a first threshold criterion for a quantity of packet data convergence protocol discarded packets is satisfied using a first threshold value that is based at least in part on the traffic service type; and
detect that a second threshold criterion for a serving cell reference signal received power is satisfied using a second threshold value that is based at least in part on the traffic service type.

18. The UE of claim 15, wherein the one or more processors, to detect that the one or more threshold criteria are satisfied, are configured to:
detect that the one or more threshold criteria are satisfied for a first quantity of occurrences based at least in part on the indication from the application processor, of whether the uplink data stall has occurred, indicating that no uplink data stall has occurred; or
detect that the one or more threshold criteria are satisfied for a second quantity of occurrences based at least in part on the indication from the application processor, of whether the uplink data stall has occurred, indicating that the uplink data stall has occurred.

19. The UE of claim 15, wherein the one or more processors are further configured to:
perform an action to bar a serving cell for a threshold amount of time based at least in part on detecting that the one or more threshold criteria are satisfied.

20. The UE of claim 15, wherein the one or more processors are further configured to:
trigger a radio link failure based at least in part on transmitting the information identifying the one or more adjusted measurement values.

21. The UE of claim 15, wherein the one or more processors are further configured to:
measure one or more signal strengths of one or more neighbor cells; and
trigger a radio link failure with a serving cell based at least in part on the one or more signal strengths of the one or more neighbor cells not being within a threshold amount of the one or more adjusted measurement values.

22. The UE of claim 21, wherein the threshold amount is based at least in part on a value of a measurement value of the serving cell.

23. The UE of claim 15, wherein the traffic service type is associated with setup signaling for an evolved packet system fallback (EPSFB) voice call, and wherein the one or more processors, to detect that the one or more threshold criteria are satisfied, are configured to:
detect that a first threshold criterion for a packet data convergence protocol discard rate is satisfied using a first threshold value that is based at least in part on the traffic service type.

24. The UE of claim 15, wherein the traffic service type is associated with setup signaling for an evolved packet system fallback (EPSFB) voice call, wherein the EPSFB voice call is associated with a first radio access technology (RAT), wherein the one or more processors are further configured to:
perform, based at least in part on detecting that the one or more threshold criteria are satisfied, an action for a redirection to establish a connection using a second RAT based at least in part on at least one of:
a measurement configuration not configuring the UE to perform measurements associated with inter-RAT neighbor cells, or
a measurement event not being satisfied, wherein the measurement event is indicated by the measurement configuration and associated with redirecting to neighbor cells associated with the second RAT.

25. The UE of claim 15, wherein the traffic service type is associated with a secondary cell group (SCG) in a dual connectivity mode, and wherein the one or more processors, to detect that the one or more threshold criteria are satisfied, are configured to:
detect that a first threshold criterion for an uplink grant rate is satisfied using a first threshold value that is based at least in part on the traffic service type;
detect that a second threshold criterion for a buffer size is satisfied using a second threshold value that is based at least in part on the traffic service type or that a third threshold criterion for a packet data convergence protocol discard rate packets is satisfied using a third threshold value that is based at least in part on the traffic service type; and
detect that a fourth threshold criterion for a serving cell reference signal received power is satisfied using a fourth threshold value that is based at least in part on the traffic service type.

26. The UE of claim 15, wherein the traffic service type is associated with a secondary cell group (SCG) in a dual connectivity mode, wherein the SCG is a primary path associated with the dual connectivity mode, wherein the one or more processors are further configured to:
perform one or more actions to mitigate the uplink data stall based at least in part on the SCG being the primary path.

27. The UE of claim 26, wherein the one or more actions include at least one of:
apply a penalty to a reference signal received power configuration associated with the SCG;
trigger a radio link failure associated with the SCG based at least in part on a handover associated with the SCG not being triggered and a value of the penalty satisfying a first threshold; or
trigger the radio link failure associated with the SCG based at least in part on measurements of one or more neighbor cells not being within a threshold amount of the one or more adjusted measurement values and the value of the penalty satisfying a second threshold.

28. The UE of claim 15, wherein the one or more adjusted measurement values are derived by applying a penalty to a first reference signal received power configuration of a cell associated with a first radio access technology (RAT), wherein the one or more processors are further configured to:
establish a connection via a second RAT; and
transmit information associated with inter-RAT measurements from the second RAT to the first RAT based at least in part on applying the penalty to a second reference signal received power configuration of the cell associated with the second RAT.

29. A non-transitory computer-readable medium storing a set of instructions for wireless communication, the set of instructions comprising:
one or more instructions that, when executed by one or more processors of a user equipment (UE), cause the UE to:
receive, from an application processor associated with the UE, an indication of a traffic service type and whether an uplink data stall has occurred;
detect that one or more threshold criteria are satisfied for a serving cell, wherein a threshold value associated with at least one of the one or more threshold criteria is based at least in part on the traffic service type; and
transmit information associated with one or more adjusted measurement values of the serving cell based at least in part on detecting that the one or more threshold criteria are satisfied.

30. An apparatus for wireless communication, comprising:
means for receiving, from an application processor associated with the apparatus, an indication of a traffic service type and whether an uplink data stall has occurred;
means for detecting that one or more threshold criteria are satisfied for a serving cell, wherein a threshold value associated with at least one of the one or more threshold criteria is based at least in part on the traffic service type; and
means for transmitting information associated with one or more adjusted measurement values of the serving cell based at least in part on detecting that the one or more threshold criteria are satisfied.
